(19) United States
(12) Patent Application Publication
(10) Pub. No.: US 2025/0249782 A1
(43) Pub. Date: Aug. 7, 2025

(54) POWER DISTRIBUTION MATRIX CIRCUIT AND SPLIT-TYPE POWER INTELLIGENT DISTRIBUTION CHARGING SYSTEM AND CONTROL METHOD THEREOF

(71) Applicant: Shenzhen HB Electronic Co., Ltd, Shenzhen City (CN)

(72) Inventors: Jianjun XU, Shenzhen City (CN); Dongyi JIANG, Shenzhen City (CN); Hongqiao QIN, Shenzhen City (CN)

(21) Appl. No.: 18/432,116

(22) Filed: Feb. 5, 2024

(51) Int. Cl. B60L 53/67; B60L 53/14; H02J 7/00; H02J 7/02

(52) U.S. Cl. CPC B60L 53/67; B60L 53/14; H02J 7/0019; H02J 7/02

(57) ABSTRACT

The present disclosure provides a power distribution matrix circuit including N charging modules configured to output charging powers, N charging interfaces configured to receive the charging power that is output, and charge an energy storage unit; a plurality of groups of controlled switches connected between the charging module and the charging interface and configured to switch on or switch off the charging interface and the charging module; an M-th module connected in parallel with a first interface, a second interface until to an M-th interface through M groups of controlled switches, respectively; each group of controlled switches connected to one charging interface; the plurality of groups of controlled switches are switched on or switched off according to power distribution strategies, so that the charging powers output by the plurality of charging interfaces have a plurality of different combinations to obtain variety of charging powers.

### TECHNICAL FIELD

The present disclosure relates to the field of energy storage charging technologies, and more particularly, to a power distribution matrix circuit and a split-type power intelligent distribution charging system and a control method thereof.

### BACKGROUND

In recent years, an energy storage market, including new energy vehicles, has grown rapidly, and charging piles have become an important link and a basis guarantee in the energy storage market. A rapid development of the energy storage market has also put forward higher requirements for a construction of charging piles.

In a related art, an energy storage charging pile mainly consists of two parts that are an AC/DC power conversion and a DC output control. At present, an AC-DC conversion module and a controller of each of an integral dual gun DC charging pile and an integral single gun DC charging pile on the market are usually integrated to each other, which has r relatively great overall volume, so that an installation area is also relatively large; when a charging power of the charging pile can't meet a charging power of the vehicle, it can't invoke powers from other idle charging piles, thereby resulting in occurring a lower charging efficiency thereof; while when the charging power of the charging pile is greater than the charging power of the vehicle, a remaining power can't be distributed to other charging guns, thereby resulting in resource waste.

Therefore, in response to the above mentioned problems of the related art, it is urgent to provide an improved split-type intelligent power distribution charging system with a plurality of charging guns and a simple structure to implement power distribution according to requirements, so as to obtain an energy storage charging technology for power distribution.

### SUMMARY

An objective of the present disclosure is to provide a split-type power intelligent distribution charging system which can solve the above technical problem of the related art that a conventional integral charging system is occurred a large installation area and unable to implement intelligent power distribution during charging new energy vehicles.

To achieve the above objective, one aspect of the present disclosure provides a split-type power intelligent distribution charging system including:
a charging rectifier cabinet configured to receive a power control unit and a power distribution matrix circuit therein, the power distribution matrix circuit including a plurality of charging interfaces;
a plurality of charging terminals connected to the charging rectifier cabinet respectively, and each of the plurality of charging terminals configured to receive a charging control unit, and a charging gun connected to each of the plurality of charging interfaces therein;
the power distribution matrix circuit including:
N charging modules including a first module, a second module, an M-th module until to an N-th module, the charging module configured to output a charging power, wherein maximum charging powers output by the first module, the second module, the M-th module until to the N-th module respectively are Q1, Q2, Qm until to Qn, and wherein Nis an integer and N≥2, N=n, M≤N, m≤n;
N charging interfaces including a first interface, a second interface, an M-th interface until to an N-th interface, the charging interface configured to receive the charging power that is output, and charge an energy storage unit;
a plurality of groups of controlled switches electrically connected between the charging module and the charging interface and configured to switch on or switch off the charging interface and the charging module; and wherein
the M-th module connected in parallel with the first interface, the second interface until to the M-th interface through M groups of controlled switches, respectively; each group of controlled switches connected to one charging interface; the plurality of groups of controlled switches are controlled to switch on or switch off according to power distribution strategies based on the number of energy storage units that are connected to the charging interface and a maximum charging power of the energy storage units, so that the charging powers output by the plurality of charging interfaces have a plurality of different combinations to obtain variety of charging powers; and wherein
the power distribution strategies include:
the M-th interface is only conductive to the M-th module through one group of controlled switches, so that the maximum charging power of the M-th interface is Qm that is the maximum charging power of the M-th module; or
the M-th interface is conductive to at least two charging modules through the controlled switch, so that the maximum charging power that are conductive to the M-th interface is a sum of the maximum charging powers of all charging modules that are conductive to the M-th interface, and only one of the plurality of controlled switches which are connected to the charging module that is conductive to the M-th interface is conducted; or
the M-the interface and the plurality of charging modules are all closed through the controlled switch, so that the maximum charging power of the M-th interface is zero; and wherein
the power control unit controls the controlled switch to be switched on or switched off based on the number of energy storage units that are connected to the plurality of charging interfaces and the maximum charging power of the energy storage unit; and wherein the charging control unit is configured to obtain the maximum charging power and/or a required charging voltage of the energy storage unit which is connected to each charging interface, and send the maximum charging power and/or the required charging voltage to the power control unit, the power control unit configured to control the plurality of groups of controlled switches to be switched on or switched off that are connected to the charging interface based on the maximum charging power and/or the required charging voltage of the energy storage unit corresponding to the charging interface, so that the charging interface is charged according to the required charging power and the required charging voltage of the energy storage unit.

The present disclosure provides the advantages as below:
the present disclosure provides the split-type power intelligent distribution charging system that the plurality of charging terminals is configured to charge the energy storage unit. When the charging gun of the charging terminal is connected to the energy storage unit, the charging control unit starts to obtain the maximum charging power and/or the required charging voltage of the energy storage unit, and sends the maximum charging power and/or the required charging voltage to the power control unit that is received in the charging rectifier cabinet, the power control unit controls at least one controlled switch of the plurality of controlled switches that are connected between the plurality of charging modules and the charging guns to be conducted according to the power distribution strategies, before the power control unit converting an AC into a DC for charging the energy storage unit, and one or more charging modules are connected in parallel to the charging gun, so that the energy storage unit can obtain a larger charging power. When other energy storage units continue to be plugged into the charging gun, the power control unit controls the controlled switches of all charging guns that are plugged into the energy storage units, to make all energy storage units obtain larger charging powers as far as possible, so as to implement a goal of intelligently distributing charging powers of the plurality of charging guns. Compared to the related art that one charging gun is corresponding to one charging module, and the charging power of the charging module is fixed, rather than being dynamically adjusted, so that when the required charging power is less than the charging power of the charging module, an excess charging power of the charging module can't be distributed to other charging guns, the present disclosure is conductive to improving charging efficiency thereof.

On the other hand, the plurality of charging terminals of the present disclosure is respectively connected to the charging rectifier cabinet in a distributed manner. In the charging rectifier cabinet, the alternating current is converted into the direct current, which is then charged by the charging module and discharged separately to the charging terminals to charge the energy storage unit. Such distribution structure can minimize a size of each charging terminal as much as possible, thereby reducing a layout area of the entire system, which is more suitable for being installed and used in small-scale sites.

The present disclosure also provides the power distribution matrix circuit used in the above-mentioned system. By controlling the controlled switches in the power distribution matrix circuit, it can intelligently implement a working way that one charging gun is corresponding to at least one charging module, so that the charging power can be flexibly distributed.

To achieve the above objective, another aspect of the present disclosure also provides a split-type power intelligent distribution charging control method, the method includes:
step S1, setting the power distribution matrix circuit as claimed in claim 1, and setting a power control unit connected to the power distribution matrix circuit and configured to control the controlled switch of the power distribution matrix circuit to be switched on or switched off; setting a charging control unit connected to the power distribution matrix circuit and configured to obtain a maximum charging power and/or a required charging voltage of the energy storage unit that is connected to the charging interface;
step S2, detecting, by the charging control unit, the energy storage units that are connected to the plurality of charging interfaces, determining positions and the number of charging interfaces that are currently connected to the energy storage units, and detecting the maximum charging power and/or a charging voltage of the energy storage units and then sending the maximum charging power and/or the charging voltage of the energy storage units to the power control unit;
step S3, controlling, by the power control unit, to switch on or switch off the controlled switch according to distribution strategies to charge the energy storage unit; and wherein
the power distribution strategies include:
the M-th interface is only conductive to the M-th module through one group of controlled switches, so that the maximum charging power of the M-th interface is Qm that is the maximum charging power of the M-th module; or
the M-th interface is conductive to at least two charging modules through the controlled switch, so that the maximum charging power that are conductive to the M-th interface is a sum of the maximum charging powers of all charging modules that are conductive to the M-th interface, and only one of the plurality of controlled switches which are connected to the charging module that is conductive to the M-th interface is conducted; or
the M-the interface and the plurality of charging modules are all closed through the controlled switch, so that the maximum charging power of the M-th interface is zero.

In the method of the present disclosure, the above power distribution strategies combined with the power distribution matrix circuit can dynamically adjust the charging power of all energy storage units that are connected to the charging interfaces. When every new energy storage unit is connected, the charging power of all charging interfaces can be adjusted in a timely manner, so that the plurality of energy storage units can be more efficiently to be charged, to reduce situations where remaining charging powers are not utilized.

### BRIEF DESCRIPTION OF THE DRAWINGS

FIG. 1 is a schematic structural diagram of a split-type power intelligent distribution charging system according to an embodiment provided by the present disclosure;

FIG. 2 is an electrical schematic diagram of a power distribution matrix circuit of the split-type power intelligent distribution charging system of FIG. 1;

FIG. 3 is an equivalent circuit diagram of an one-to-one connection between a charging interface and a charging module of the power distribution matrix circuit of FIG. 2; and

FIG. 4 is a schematic diagram of a split-type power intelligent distribution charging control method according to an embodiment provided by the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skilled in the related art on the premise of no creative work are within the protection scope of the present disclosure.

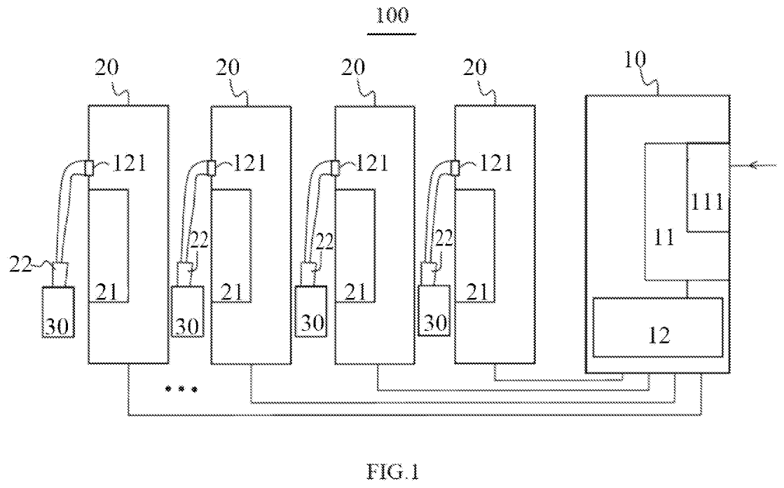

Referring to FIG. 1, a split-type power intelligent distribution charging system 100 according to an embodiment of the present disclosure is provided. The system 100 includes a charging rectifier cabinet 10 and a plurality of charging terminals 20 arranged in a split-type mode and connected to the charging rectifier cabinet 10 respectively. The charging rectifier cabinet 10 is configured to receive a power control unit 11 and a power distribution matrix circuit 12 therein. The power distribution matrix circuit 12 includes a plurality of charging interfaces 121, and each of the plurality of charging terminals 20 is configured to receive a charging control unit 21 and a charging gun 22 connected to the charging interface 121 therein.

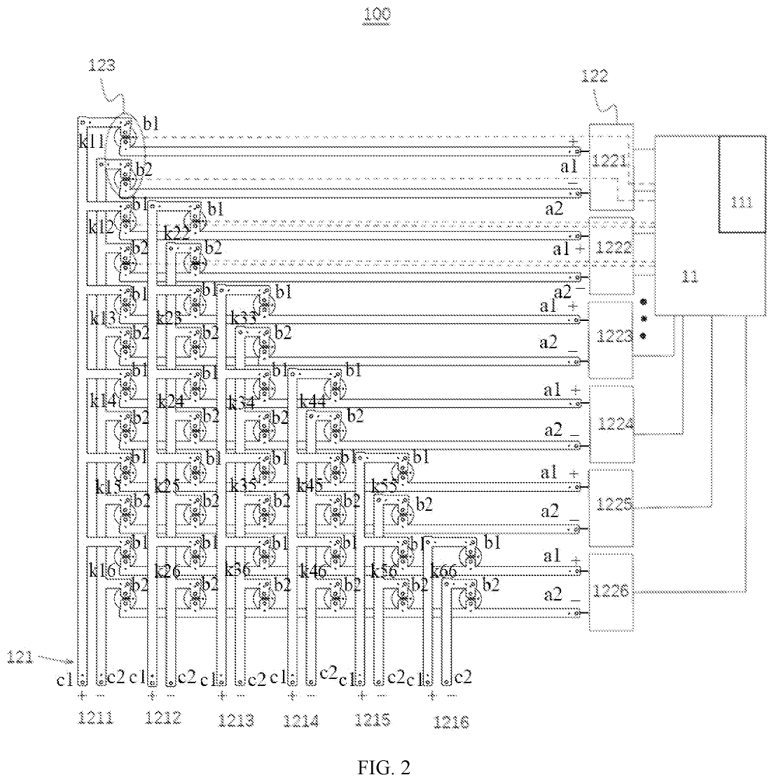

Referring to FIG. 2, in the present disclosure, the power distribution matrix circuit 12 includes N charging modules 122, N charging interfaces 121 and a plurality of groups of controlled switches 123. The N charging modules 122 includes a first module, a second module, an M-th module until to an N-th module, the charging module 121 configured to output a charging power, wherein maximum charging powers output by the first module, the second module, the M-th module until to the N-th module respectively are Q1, Q2, Qm until to Qn, and wherein Nis an integer and N≥2, N=n, M≤N, msn. The N charging interfaces 121 includes a first interface, a second interface, an M-th interface until to an N-th interface, the charging interface 122 configured to receive the charging power that is output, and charge an energy storage unit 30 through the charging gun 22. The controlled switch 123 is electrically connected between the charging module 122 and the charging interface 121 and configured to switch on or switch off the charging interface 121 and the charging module 122.

It should be noted that in the power distribution matrix circuit 12, the M-th module connected in parallel with the first interface, the second interface until to the M-th interface through M groups of controlled switches 123, respectively; each group of controlled switches 123 connected to one charging interface 121. The plurality of groups of controlled switches 123 are controlled to switch on or switch off according to power distribution strategies based on the number of energy storage units 30 that are connected to the charging interface 121 and a maximum charging power of the energy storage units 30, so that the charging powers output by the plurality of charging interfaces 121 have a plurality of different combinations to obtain variety of charging powers.

The power distribution strategies include:
the M-th interface is only conductive to the M-th module through one group of controlled switches 123, so that the maximum charging power of the M-th interface is Qm that is the maximum charging power of the M-th module; or
the M-th interface is conductive to at least two charging modules 122 through the controlled switch 123, so that the maximum charging power that are conductive to the M-th interface is a sum of the maximum charging powers of all charging modules 122 that are conductive to the M-th interface, and only one of the plurality of controlled switches 123 which are connected to the charging module 122 that is conductive to the M-th interface is conducted; or
the M-the interface and the plurality of charging modules 123 are all closed through the controlled switch 123, so that the maximum charging power of the M-th interface is zero; and wherein
the power control unit 11 is connected to the plurality of charging control units 21, the plurality of charging control units 21 configured to respectively obtain the maximum charging power and/or a required charging voltage of the energy storage unit 30 which is connected to each charging interface 121, and then send the maximum charging power and/or the required charging voltage to the power control unit 11. The power control unit 11 is connected to the power distribution matrix circuit 12, and is specifically connected to the charging module 122 of the power distribution matrix circuit 12. The power control unit 11 is configured to control to switch on or switch off the plurality of controlled switches 123 that is connected to the plurality of charging interfaces 121 based on the maximum charging power and/or the required charging voltage of the energy storage unit 30 corresponding to the charging interface 121, so that the charging interface 121 can be charged according to the required charging power and the required charging voltage of the energy storage unit 30.

In the present disclosure, the power control unit 11 includes an AC-DC conversion module 111 configured to convert an alternating current (AC) to a direct current (DC) and then send the DC to the charging module 122 and the charging interface 121 through the power control unit 11 for charging the energy storage unit 30. The charging gun 22 is plugged into the energy storage unit 30 to obtain the maximum charging power and/or the required charging voltage of the energy storage unit 30 through the charging control unit 21, so as to charge the energy storage unit 30.

In the present disclosure, each charging module 122 includes a charging positive electrode a1 and a charging negative electrode a2, each group of controlled switches 123 including a positive switch b1 and a negative switch b2, and each charging interface 121 including a positive terminal c1 and a negative terminal c2; the charging positive electrode a1 of the N-th module connected in parallel to each of positive terminals c1 of the first interface, the second interface until to the N-th interface through the positive switches b1 of the N groups of controlled switches 123, and the charging negative electrode a2 of the N-th module connected in parallel to each of negative terminals c2 of the first interface, the second interface until to the N-th interface through the negative switches b2 of the N groups of controlled switches 123.

In the present disclosure, the M-th module represents any M-th module among the N charging modules 122. In order to further describe a working status of the system 100, N, Q1, Q2, Qm until to Qn are respectively taken as the following values.

Referring to FIG. 2, in an embodiment of the present disclosure, N is equal to six, that is, the system 100 includes six charging modules 122, namely a first module 1221, a second module 1222, a third module 1223, a fourth module 1224, a fifth module 1225 and a sixth module 1226. The system 100 also includes six charging interfaces 121, namely a first interface 1211, a second interface 1212, a third interface 1213, a fourth interface 1214, a fifth interface 1215 and a sixth interface 1216.

The charging powers of the first module 1221, the second module 1222, the third module 1223, the fourth module 1224, the fifth module 1225 and the sixth module 1226 are respectively taken as follows: Q1=10 KW, Q2=20 KW, Q3=30 KW, Q4=40 KW, Q5=50 KW, Q6=60 KW.

In an embodiment of the present disclosure, the first module 1221 is connected to the first interface 1211 through a group of controlled switches 23, while the second module 1222 is connected in parallel with the first interface 1211 and the second interface 1212 through two groups of controlled switches 123, respectively. The third module 1223 is connected in parallel with the first interface 1211, the second interface 1212 and the third interface 1213 through three groups of controlled switches 123, respectively. The fourth module 1224 is connected in parallel with the first interface 1211, the second interface 1212, the third interface 1213 and the fourth interface 1214 through four groups of controlled switches 123, respectively. The fifth module 1225 is connected in parallel with the first interface 1211, the second interface 1212, the third interface 1213, the fourth interface 1214 and the fifth interface 1215 through five groups of controlled switches 123, respectively. The sixth module 1226 is connected in parallel with the first interface 1211, the second interface 1212, the third interface 1213, the fourth interface 1214, the fifth interface 1215 and the sixth interface 1216 through six groups of controlled switches 123, respectively. In an embodiment of the present disclosure, there are six groups of controlled switches 123 are simultaneously conducted among all controlled switches 123 at most, and each charging module 122 can be conductive to the charging interface 121 through only one conductive controlled switch 123.

A counter-example is that when two controlled switches 123 connected to one charging module 122 are conducted simultaneously, that is, the one charging module 122 will simultaneously charge the energy storage units 30 that are connected to two charging interfaces 121. However, when the two energy storage units 30 are charged, there will inevitably be fluctuations and differences between two charging voltages of the two energy storage units 30. In this situation, it will cause that a high charging voltage or a low charging voltage is occurred in one of the two energy storage units 30, so that one of the two energy storage units 30 will experience an abnormal charging, thereby being stopped charging, and there is a risk of damaging the energy storage unit 30. Therefore, in the present disclosure, a situation that the same charging module 122 charges two energy storage units 30 simultaneously is avoided as far as possible.

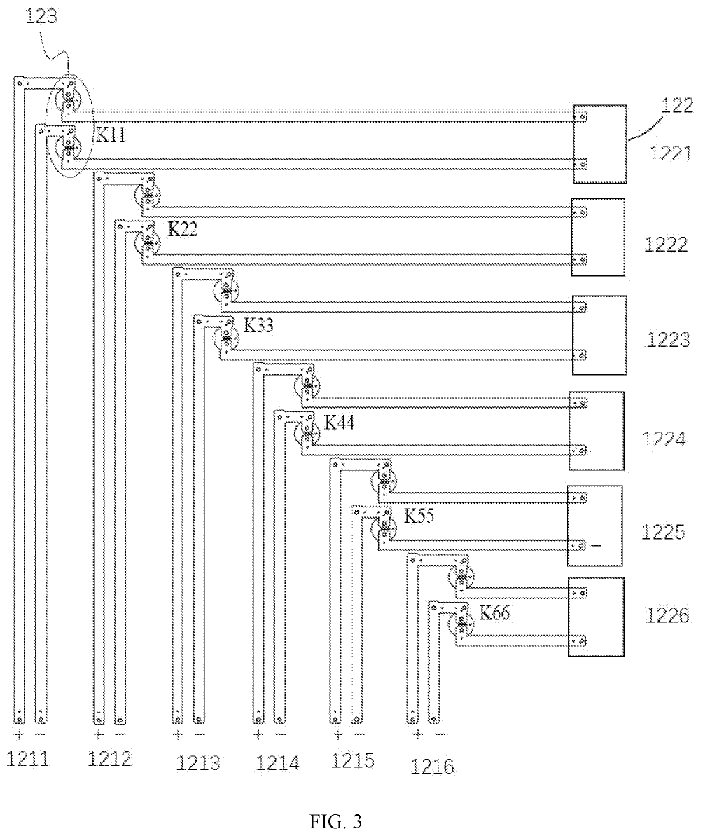

In order to clearly describe situations of the charging power of each charging interface 121 in the embodiment of the present disclosure, the following table 1 and FIG. 3 are combined to illustrate.

In table 1, a switch K13 represents the controlled switch that is connected to the third module 1223 and the first interface 1211, while a switch K45 represents the controlled switch that is connected to the fifth module 1225 and the fourth interface 1214.

TABLE 1
Conductive status of controlled switch in power distribution matrix circuit and charging power distribution thereof

| | | | | | | | | | | | | | | Power of |
|---|---|---|---|---|---|---|---|---|---|---|---|---|---|---|
| Charging | First | | Second | | Third | | Fourth | | Fifth | | Sixth | | Charging | charging |
| interface | interface | | interface | | interface | | interface | | interface | | interface | | module | module |
| Status of | Switch | ▪ | | | | | | | | | | | First | 10 KW |
| controlled | K11 | | | | | | | | | | | | module | |
| switch | Switch | □ | Switch | ▪ | | | | | | | | | Second | 20 KW |
| □representing | K12 | | K22 | | | | | | | | | | module | |
| switch off | Switch | □ | Switch | □ | Switch | ▪ | | | | | | | Third | 30 KW |
| ▪representing | K13 | | K23 | | K33 | | | | | | | | module | |
| switch on | Switch | □ | Switch | □ | Switch | □ | Switch | ▪ | | | | | Fourth | 40 KW |
| | K14 | | K24 | | K34 | | K44 | | | | | | module | |
| | Switch | □ | Switch | □ | Switch | □ | Switch | □ | Switch | ▪ | | | Fifth | 50 KW |
| | K15 | | K25 | | K35 | | K45 | | K55 | | | | module | |
| | Switch | □ | Switch | □ | Switch | □ | Switch | □ | Switch | □ | Switch | ▪ | Sixth | 60 KW |
| | K16 | | K26 | | K36 | | K46 | | K56 | | K66 | | module | |
| Power of | 10 KW | | 20 KW | | 30 KW | | 40 KW | | 50 KW | | 60 KW | | Total | 210 KW |
| charging | | | | | | | | | | | | | charging | |
| interface | | | | | | | | | | | | | power | |

In an embodiment of the present disclosure, when each charging interface 121 is connected to the energy storage unit 30, and the maximum charging powers of the energy storage units 30 that are connected to the first interface 1211 to the sixth interface 1216 are respectively less than 10 KW, 20 KW, 30 KW, 40 KW, 50 KW and 60 KW in turn, the power control unit 11 controls the controlled switch 123 to make that the first module 1221 of the power distribution matrix circuit 12 is conductive to the first interface 1211 through the controlled switch K11, the second module 1222 is conductive to the second interface 1212 through the controlled switch K22, the third module 1223 is conductive to the third interface 1213 through the controlled switch K33, the fourth module 1224 is conductive to the fourth interface 1214 through the controlled switch K44, the fifth module 1225 is conductive to the fifth interface 1215 through the controlled switch K55, and the sixth module 1226 is conductive to the sixth interface 1216 through the controlled switch K66. In this way, the first interface 1211 outputs a charging power of 10 KW, the second interface 1212 outputs a charging power of 20 KW, the third interface 1213 outputs a charging power of 30 KW, the fourth interface 1214 outputs a charging power of 40 KW, the fifth interface 1215 outputs a charging power of 50 KW, and the sixth interface 1216 outputs a charging power of 60 KW, which allows for efficiently charging the energy storage unit 30 based on the number of energy storage units 30 that are connected and their respective maximum charging power, thereby ensuring that each energy storage unit 30 can be charged under around the maximum charging power so as to reduce times for charging the energy storage unit 30.

Under the same connection method, when a demand and a quantity of the maximum charging power of the energy storage unit 30 connected to the charging interface 121 are different, control ways of the controlled switches 123 by the power control unit 11 are also different, as shown in table 2 below:

TABLE 2
Conductive status of controlled switch in power distribution matrix circuit and charging power distribution thereof

| | | | | | | | | | | | | | | Power of |
|---|---|---|---|---|---|---|---|---|---|---|---|---|---|---|
| Charging | First | | Second | | Third | | Fourth | | Fifth | | Sixth | | Charging | charging |
| interface | interface | | interface | | interface | | interface | | interface | | interface | | module | module |
| Status of | Switch | ▪ | | | | | | | | | | | First | 10 KW |
| controlled | K11 | | | | | | | | | | | | module | |
| switch | Switch | ▪ | Switch | □ | | | | | | | | | Second | 20 KW |
| □representing | K12 | | K22 | | | | | | | | | | module | |
| switch off | Switch | □ | Switch | □ | Switch | ▪ | | | | | | | Third | 30 KW |
| ▪representing | K13 | | K23 | | K33 | | | | | | | | module | |
| switch on | Switch | □ | Switch | □ | Switch | ▪ | Switch | □ | | | | | Fourth | 40 KW |
| | K14 | | K24 | | K34 | | K44 | | | | | | module | |
| | Switch | □ | Switch | □ | Switch | □ | Switch | □ | Switch | ▪ | | | Fifth | 50 KW |
| | K15 | | K25 | | K35 | | K45 | | K55 | | | | module | |
| | Switch | □ | Switch | □ | Switch | □ | Switch | □ | Switch | ▪ | Switch | □ | Sixth | 60 KW |
| | K16 | | K26 | | K36 | | K46 | | K56 | | K66 | | module | |
| Power of | 30 KW | | 0 KW | | 70 KW | | 0 KW | | 110 KW | | 0 KW | | Total | 210 KW |
| charging | | | | | | | | | | | | | charging | |
| interface | | | | | | | | | | | | | power | |

In table 2, a switch K11 represents the controlled switch that is connected to the first module 1221 and the first interface 1211, while a switch K56 represents the controlled switch that is connected to the sixth module 1226 and the fifth interface 1215.

It can be seen from table 2 that when the energy storage units 30 are only connected to the first interface 1211, the third interface 1213 and the fifth interface 1215, other charging interfaces 121 are not connected to the energy storage units 30, and the maximum charging power of the energy storage unit 30 that is connected to the first interface 1211 is less than 30 KW, the maximum charging power of the energy storage unit 30 that is connected to the third interface 1213 is less than 70 KW, and the maximum charging power of the energy storage unit 30 that is connected to the fifth interface 1215 is less than 110 KW, the power control unit 11 controls both the controlled switch K11 and the controlled switch K12 to be conducted, so that both the first module 1221 and the second module 1222 of the power distribution matrix circuit 12 are connected to the first interface 1211. The power control unit 11 controls both the controlled switch K33 and the controlled switch K34 to be conducted, so that both the third module 1223 and the fourth module 1224 of the power distribution matrix circuit 12 are connected to the third interface 1213. The power control unit 11 controls both the controlled switch K55 and the controlled switch K56 to be conducted, so that both the fifth module 1225 and the sixth module 1226 of the power distribution matrix circuit 12 are connected to the fifth interface 1215. In this way, the charging power output by the first interface 1211 is a sum of the maximum charging power of the first module 1221 and the maximum charging power of the second module 1222, which is 30 KW. Similarly, the third interface 1213 outputs the maximum charging power of 70 KW, and the fifth interface 1215 outputs the maximum charging power of 110 KW. However, the other charging interfaces 121 are not conductive to the charging module 122, so that the charging powers output by the other charging interfaces 121 are zero. The power control unit 11 is provided to control the controlled switch 123 based on the maximum charging power of the energy storage unit 30, so that the plurality of energy storage units 30 can be charged in a combination state with different maximum charging powers, so as to meet various charging requirements.

It can be seen from the above two implementation methods that a total sum of the maximum charging powers of the first module 1221 to the sixth module 1226 is 210 KW. However, when charging the six energy storage units 30 according to table 1 and only charging three energy storage units 30 that are connected according to table 2, the total sum of the maximum charging powers of the plurality of energy storage units 30 is also 210 KW, which can perform intelligent distribution of charging powers on the energy storage units 30, so that there is no excess and unused charging powers thereof.

Of course, in the present disclosure, the number of charging modules 122 and the number of charging interfaces 121 can also be other values, such as eight charging modules 122 and eight charging interfaces 121 respectively. As the number of charging modules 122 increases, the number of controlled switches 123 to be controlled by the power control unit 11 also increases. However, as long as the following requirements are met and controlled according to the power distribution strategies of the present disclosure.

First, the M-th module connected in parallel with the first interface, the second interface until to the M-th interface through the M groups of controlled switches 123. Each group of controlled switches 123 is connected to one charging interface 121, and M is any natural number from one to eight.

Second, there are at most M groups of controlled switches 123 to be conducted simultaneously among all the controlled switches 123, and each charging module 122 is conductive to the charging interface 121 through only one conductive controlled switch 123, wherein M is equal to eight.

Third, at most one of the plurality of controlled switches 123 connected to the charging module 122 that is conductive to the M-the interface is conductive, and M is any natural number from one to eight.

A most typical application of the present disclosure is that there are six charging modules 122, the six charging modules 122 output the same charging powers of 60 KW, and there are also six charging interfaces 121.

At this time, when the energy storage units 30 are connected to all six charging interfaces 121, and the maximum charging power of each energy storage unit 30 is less than 60 KW, the controlled switch 123 controlled by the power control unit 11 to be conducted is the same as that of table 1, which can ensure that the six charging interfaces 121 also output the same charging powers, i.e. 60 KW, as shown in table 3 below:

TABLE 3
Conductive status of controlled switch in power distribution matrix circuit and charging power distribution thereof

| | | | | | | | | | | | | | | Power of |
|---|---|---|---|---|---|---|---|---|---|---|---|---|---|---|
| Charging | First | | Second | | Third | | Fourth | | Fifth | | Sixth | | Charging | charging |
| interface | interface | | interface | | interface | | interface | | interface | | interface | | module | module |
| Status of | Switch | ▪ | | | | | | | | | | | First | 60 KW |
| controlled | K11 | | | | | | | | | | | | module | |
| switch | Switch | □ | Switch | ▪ | | | | | | | | | Second | 60 KW |
| □representing | K12 | | K22 | | | | | | | | | | module | |
| switch off | Switch | □ | Switch | □ | Switch | ▪ | | | | | | | Third | 60 KW |
| ▪representing | K13 | | K23 | | K33 | | | | | | | | module | |
| switch on | Switch | □ | Switch | □ | Switch | □ | Switch | ▪ | | | | | Fourth | 60 KW |
| | K14 | | K24 | | K34 | | K44 | | | | | | module | |
| | Switch | □ | Switch | □ | Switch | □ | Switch | □ | Switch | ▪ | | | Fifth | 60 KW |
| | K15 | | K25 | | K35 | | K45 | | K55 | | | | module | |
| | Switch | □ | Switch | □ | Switch | □ | Switch | □ | Switch | □ | Switch | ▪ | Sixth | 60 KW |
| | K16 | | K26 | | K36 | | K46 | | K56 | | K66 | | module | |
| Power of | 60 KW | | 60 KW | | 60 KW | | 60 KW | | 60 KW | | 60 KW | | Total | 360 KW |
| charging | | | | | | | | | | | | | charging | |
| interface | | | | | | | | | | | | | power | |

At this time, when only the first interface 1211, the fourth interface 1214 and the sixth interface 1216 of the six charging interfaces 121 are connected to the energy storage units 30, and the maximum charging powers of the energy storage units 30 are different, for example, the maximum charging power of the energy storage unit 30 on the first interface 1211 is less than 180 KW, the maximum charging power of the energy storage unit 30 on the fourth interface 1214 is less than 120 KW, and the maximum charging power of the energy storage unit 30 on the sixth interface 1216 is less than 60 KW, the power control unit 11 controls all of the controlled switch K11, the controlled switch K12, the controlled switch K13, the controlled switch K44, the controlled switch K45 and the controlled switch K66 to be conducted, as shown in table 4. At this time, the maximum charging powers output by the first interface 1211, the fourth interface 1214 and the sixth interface 1216 are 180 KW, 120 KW and 60 KW, respectively. In this way, the charging system 100 of the present disclosure can ensure that each energy storage unit 30 that is connected receives the maximum charging power, for intelligently distributing the charging powers.

TABLE 4
Conductive status of controlled switch in power distribution matrix circuit and charging power distribution thereof

| | | | | | | | | | | | | | | Power of |
|---|---|---|---|---|---|---|---|---|---|---|---|---|---|---|
| Charging | First | | Second | | Third | | Fourth | | Fifth | | Sixth | | Charging | charging |
| interface | interface | | interface | | interface | | interface | | interface | | interface | | module | module |
| Status of | Switch | ▪ | | | | | | | | | | | First | 60 KW |
| controlled | K11 | | | | | | | | | | | | module | |
| switch | Switch | ▪ | Switch | □ | | | | | | | | | Second | 60 KW |
| □representing | K12 | | K22 | | | | | | | | | | module | |
| switch off | Switch | ▪ | Switch | □ | Switch | □ | | | | | | | Third | 60 KW |
| ▪representing | K13 | | K23 | | K33 | | | | | | | | module | |
| switch on | Switch | □ | Switch | □ | Switch | □ | Switch | ▪ | | | | | Fourth | 60 KW |
| | K14 | | K24 | | K34 | | K44 | | | | | | module | |
| | Switch | □ | Switch | □ | Switch | □ | Switch | ▪ | Switch | □ | | | Fifth | 60 KW |
| | K15 | | K25 | | K35 | | K45 | | K55 | | | | module | |
| | Switch | □ | Switch | □ | Switch | □ | Switch | □ | Switch | □ | Switch | ▪ | Sixth | 60 KW |
| | K16 | | K26 | | K36 | | K46 | | K56 | | K66 | | module | |
| Power of | 180 KW | | 0 KW | | 60 KW | | 120 KW | | 0 KW | | 60 KW | | Total | 360 KW |
| charging | | | | | | | | | | | | | charging | |
| interface | | | | | | | | | | | | | power | |

In the present disclosure, the number of controlled switches 123 that are conductive on each charging interface 121 is related to the maximum charging power of the energy storage unit 30 that is connected to each charging interface 121. When the maximum charging power of the energy storage unit 30 is greater than the charging power of a single charging module 122, it needs at least two controlled switches 123 to be conducted; when the maximum charging power of the energy storage unit 30 is greater than a sum of the charging powers of two charging modules 122, it needs three controlled switches 123 to be conducted. However, in the power intelligent distribution charging system 100 of the present disclosure, the number of controlled switches 123 that are simultaneously conducted can't be greater than that of the charging modules 122.

In the present disclosure, when the plurality of charging interfaces 121 are connected to new energy storage units 30, the charging control unit 21 detects current maximum charging powers of all energy storage units 30 that are connected to the charging interface 121, and the power control unit 11 distributes charging powers to the new energy storage units 30 that are connected according to the charging strategies.

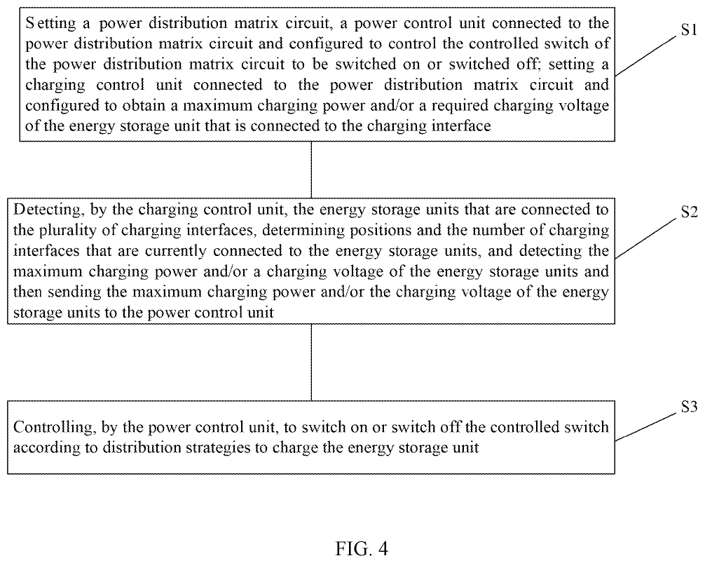

Referring to FIG. 4, the present disclosure also provides a split-type power intelligent distribution charging control method, the method includes the following steps:
step S1, setting a power distribution matrix circuit 12 and setting a power control unit 11 connected to the power distribution matrix circuit 12 and configured to control the controlled switch 123 of the power distribution matrix circuit 12 to be switched on or switched off; setting a charging control unit 21 connected to the power distribution matrix circuit 12 and configured to obtain a maximum charging power and/or a required charging voltage of an energy storage unit 30 that is connected to the charging interface 121;
step S2, detecting, by the charging control unit 21, the energy storage units 30 that are connected to the plurality of charging interfaces 121, determining positions and the number of charging interfaces 121 that are currently connected to the energy storage units 30, and detecting the maximum charging power and/or a charging voltage of the energy storage units 30 and then sending the maximum charging power and/or the charging voltage of the energy storage units 30 to the power control unit 21; and
step S3, controlling, by the power control unit 21, to switch on or switch off the controlled switch 123 according to distribution strategies to charge the energy storage unit 30.

The maximum charging powers of the plurality of charging modules 122 are the same, which is respectively equal to 60 KW, there are six charging modules and there are also six charging interfaces 121.

When the maximum charging power of the energy storage unit 30 of the M-th charging interface 121 (M≤6) is less than 60 KW, the M-th interface is only conductive to the M-th module through one group of controlled switches 123, so that the maximum charging power of the M-th interface is equal to the maximum charging power of the M-th module. When the maximum charging power of the energy storage unit 30 of the M-th charging interface 121 (M≤6) increases by no more than 60 KW, the controlled switch 123 that is conductive to the M-th interface increases by one. However, in the entire power intelligent distribution charging system 100, the number of controlled switches 123 that are conducted at the same time can't be greater than that of charging modules 122, and only one controlled switch 123 that is connected to each charging module 122 can be conducted.

According to the disclosure and teachings in the above specification, for those ordinary skilled in the art of the present disclosure, all modifications, equivalent substitutions and improvements to the aforementioned embodiments can be made within the spirit and principles of the present disclosure. Therefore, the present disclosure is not intended to limit the specific embodiments disclosed and described above, and some modifications and improvements to the present disclosure should also fall within the scope of protection of the claims of the present disclosure. Furthermore, some specific terms are used in the above specification are only for conveniently describing the present disclosure, rather than being intended to limit the present disclosure.

What is claimed is:

1. A power distribution matrix circuit comprising:
N charging modules comprising a first module, a second module, an M-th module until to an N-th module, the charging module configured to output a charging power, wherein maximum charging powers output by the first module, the second module, the M-th module until to the N-th module respectively are Q1, Q2, Qm until to Qn, and wherein Nis an integer and N≥2, N=n, M≤N, m≤n;
N charging interfaces comprising a first interface, a second interface, an M-th interface until to an N-th interface, the charging interface configured to receive the charging power that is output, and charge an energy storage unit;
a plurality of groups of controlled switches electrically connected between the charging module and the charging interface and configured to switch on or switch off the charging interface and the charging module; and wherein
the M-th module connected in parallel with the first interface, the second interface until to the M-th interface through M groups of controlled switches, respectively; each group of controlled switches connected to one charging interface; the plurality of groups of controlled switches are controlled to switch on or switch off according to power distribution strategies based on the number of energy storage units that are connected to the charging interface and a maximum charging power of the energy storage units, so that the charging powers output by the plurality of charging interfaces have a plurality of different combinations to obtain variety of charging powers; and wherein
the power distribution strategies comprise:
the M-th interface is only conductive to the M-th module through one group of controlled switches, so that the maximum charging power of the M-th interface is Qm that is the maximum charging power of the M-th module; or
the M-th interface is conductive to at least two charging modules through the controlled switch, so that the maximum charging power that are conductive to the M-th interface is a sum of the maximum charging powers of all charging modules that are conductive to the M-th interface, and only one of the plurality of controlled switches which are connected to the charging module that is conductive to the M-th interface is conducted; or
the M-the interface and the plurality of charging modules are all closed through the controlled switch, so that the maximum charging power of the M-th interface is zero.

2. The power distribution matrix circuit as claimed in claim 1, wherein maximum charging powers of the N charging modules are the same, which are respectively taken as Q, and wherein a total sum of the maximum charging powers output by the power distribution matrix circuit is N*Q.

3. The power distribution matrix circuit according to claim 2, wherein at most N groups of controlled switches in all groups of controlled switches are simultaneously conducted, and each charging module is conductive to the charging interface through only one controlled switch that is conducted.

4. The power distribution matrix circuit as claimed in claim 3, wherein N is equal to six and Q is equal to 60 KW.

5. The power distribution matrix circuit as claimed in claim 1, wherein each charging module comprises a charging positive electrode and a charging negative electrode, each group of controlled switches comprising a positive switch and a negative switch, and each charging interface comprising a positive terminal and a negative terminal; the charging positive electrode of the N-th module connected in parallel to each of positive terminals of the first interface, the second interface until to the N-th interface through the positive switches of the N groups of controlled switches, and the charging negative electrode of the N-th module connected in parallel to each of negative terminals of the first interface, the second interface until to the N-th interface through the negative switches of the N groups of controlled switches.

6. The power distribution matrix circuit as claimed in claim 1, wherein the power distribution matrix circuit is connected to a power control unit that is configured to electrically connect to the plurality of groups of controlled switches and control to switch on or switch off the plurality of groups of controlled switches, and the power control unit controls the controlled switch to be switched on or switched off based on the number of energy storage units that are connected to the plurality of charging interfaces and the maximum charging power of the energy storage unit.

7. The power distribution matrix circuit as claimed in claim 6, wherein the power control unit is connected to a plurality of charging control units that are configured to respectively obtain the maximum charging power and/or a required charging voltage of the energy storage unit which is connected to each charging interface, and send the maximum charging power and/or the required charging voltage to the power control unit, the power control unit configured to control the plurality of groups of controlled switches to be switched on or switched off that are connected to the charging interface based on the maximum charging power and/or the required charging voltage of the energy storage unit corresponding to the charging interface, so that the charging interface is charged according to the required charging power and the required charging voltage of the energy storage unit.

8. The power distribution matrix circuit as claimed in claim 7, wherein the power control unit comprises an AC-DC conversion module configured to convert an alternating current (AC) to a direct current (DC) and then send the DC to the charging interface the power control unit.

9. The power distribution matrix circuit as claimed in claim 8, wherein each charging interface is connected to a charging gun, the charging gun plugged into the energy storage unit to obtain the maximum charging power and/or the required charging voltage of the energy storage unit, so as to charge the energy storage unit.

10. A split-type power intelligent distribution charging system comprising:
a charging rectifier cabinet configured to receive a power control unit and a power distribution matrix circuit therein;
a plurality of charging terminals connected to the charging rectifier cabinet respectively, and each of the plurality of charging terminals configured to receive a charging control unit, a charging interface and a charging gun connected to the charging interface therein;
the power distribution matrix circuit comprising:
N charging modules comprising a first module, a second module, an M-th module until to an N-th module, the charging module configured to output a charging power, wherein maximum charging powers output by the first module, the second module, the M-th module until to the N-th module respectively are Q1, Q2, Qm until to Qn, and wherein Nis an integer and N≥2, N=n, M≤N, m≤n;
N charging interfaces comprising a first interface, a second interface, an M-th interface until to an N-th interface, the charging interface configured to receive the charging power that is output, and charge an energy storage unit;
a plurality of groups of controlled switches electrically connected between the charging module and the charging interface and configured to switch on or switch off the charging interface and the charging module; and wherein
the M-th module connected in parallel with the first interface, the second interface until to the M-th interface through M groups of controlled switches, respectively; each group of controlled switches connected to one charging interface; the plurality of groups of controlled switches are controlled to switch on or switch off according to power distribution strategies based on the number of energy storage units that are connected to the charging interface and a maximum charging power of the energy storage units, so that the charging powers output by the plurality of charging interfaces have a plurality of different combinations to obtain variety of charging powers; and wherein
the power distribution strategies comprise:
the M-th interface is only conductive to the M-th module through one group of controlled switches, so that the maximum charging power of the M-th interface is Qm that is the maximum charging power of the M-th module; or
the M-th interface is conductive to at least two charging modules through the controlled switch, so that the maximum charging power that are conductive to the M-th interface is a sum of the maximum charging powers of all charging modules that are conductive to the M-th interface, and only one of the plurality of controlled switches which are connected to the charging module that is conductive to the M-th interface is conducted; or
the M-the interface and the plurality of charging modules are all closed through the controlled switch, so that the maximum charging power of the M-th interface is zero; and wherein
the power control unit controls the controlled switch to be switched on or switched off based on the number of energy storage units that are connected to the plurality of charging interfaces and the maximum charging power of the energy storage unit; and wherein the charging control unit is configured to obtain the maximum charging power and/or a required charging voltage of the energy storage unit which is connected to each charging interface, and send the maximum charging power and/or the required charging voltage to the power control unit, the power control unit configured to control the plurality of groups of controlled switches to be switched on or switched off that are connected to the charging interface based on the maximum charging power and/or the required charging voltage of the energy storage unit corresponding to the charging interface, so that the charging interface is charged according to the required charging power and the required charging voltage of the energy storage unit.

11. The split-type power intelligent distribution charging system as claimed in claim 10, wherein maximum charging powers of the N charging modules are the same, which are respectively taken as Q, and wherein a total sum of the maximum charging powers output by the power distribution matrix circuit is N*Q.

12. The split-type power intelligent distribution charging system as claimed in claim 11, wherein N is equal to six and Q is equal to 60 KW, a maximum charging power of the split-type power intelligent distribution charging system is 360 KW, a minimum charging power of each charging gun is 60 KW, and a maximum charging power of each charging gun is 360 KW.

13. The split-type power intelligent distribution charging system as claimed in claim 10, wherein at most N groups of controlled switches in all groups of controlled switches are simultaneously conducted, and each charging module is conductive to the charging interface through only one controlled switch that is conducted.

14. The split-type power intelligent distribution charging system as claimed in claim 10, wherein the power control unit comprises an AC-DC conversion module configured to convert an alternating current (AC) to a direct current (DC) and then send the DC to the charging interface the power control unit.

15. A split-type power intelligent distribution charging control method comprising the following steps:
step S1, setting the power distribution matrix circuit as claimed in claim 1, and setting a power control unit connected to the power distribution matrix circuit and configured to control the controlled switch of the power distribution matrix circuit to be switched on or switched off; setting a charging control unit connected to the power distribution matrix circuit and configured to obtain a maximum charging power and/or a required charging voltage of the energy storage unit that is connected to the charging interface;
step S2, detecting, by the charging control unit, the energy storage units that are connected to the plurality of charging interfaces, determining positions and the number of charging interfaces that are currently connected to the energy storage units, and detecting the maximum charging power and/or a charging voltage of the energy storage units and then sending the maximum charging power and/or the charging voltage of the energy storage units to the power control unit;
step S3, controlling, by the power control unit, to switch on or switch off the controlled switch according to distribution strategies to charge the energy storage unit; and wherein
the power distribution strategies comprise:
the M-th interface is only conductive to the M-th module through one group of controlled switches, so that the maximum charging power of the M-th interface is Qm that is the maximum charging power of the M-th module; or
the M-th interface is conductive to at least two charging modules through the controlled switch, so that the maximum charging power that are conductive to the M-th interface is a sum of the maximum charging powers of all charging modules that are conductive to the M-th interface, and only one of the plurality of controlled switches which are connected to the charging module that is conductive to the M-th interface is conducted; or
the M-the interface and the plurality of charging modules are all closed through the controlled switch, so that the maximum charging power of the M-th interface is zero.

16. The split-type power intelligent distribution charging control method as claimed in claim 15, wherein maximum charging powers of the plurality of charging modules are the same, which is respectively equal to 60 KW, there are six charging modules and there are also six charging interfaces.

17. The split-type power intelligent distribution charging control method as claimed in claim 16, wherein when the maximum charging power of the energy storage unit of the M-th charging interface (M≤6) is less than 60 KW, the M-th interface is only conductive to the M-th module through one group of controlled switches, so that the maximum charging power of the M-th interface is equal to the maximum charging power of the M-th module;
when the maximum charging power of the energy storage unit of the M-th charging interface (M≤6) is greater than 60 KW and less than 360 KW, the M-th interface is conducted through at least two charging modules, so that the maximum charging power of the M-th interface is a sum of the maximum charging powers of all charging modules that are conductive to the M-th interface, and only one of the plurality of controlled switches which are connected to the charging module that is conductive to the M-th interface is conducted; and
when the charging power of the energy storage unit of the M-the interface is cut off or stopped, the M-the interface and the plurality of charging modules are all closed through the controlled switch, so that the maximum charging power of the M-th interface is zero.

18. The split-type power intelligent distribution charging control method as claimed in claim 15, wherein when the plurality of charging interfaces is connected to new energy storage units, the charging control unit is configured to detect current maximum charging powers of all energy storage units that are connected to the plurality of charging interfaces, and the power control unit is configured to distribute the charging powers to the new energy storage units that are connected according to the charging strategies.
